(19) United States
(12) Patent Application Publication
(10) Pub. No.: US 2025/0096224 A1
(43) Pub. Date: Mar. 20, 2025

(54) METHOD OF PRODUCING ELECTRODE, AND METHOD OF PRODUCING SECONDARY BATTERY

(71) Applicant: TOYOTA JIDOSHA KABUSHIKI KAISHA, Aichi-ken (JP)

(72) Inventors: Tomofumi HIRUKAWA, Miyoshi-shi (JP); Toru KOMATSUZAKI, Toyota-shi (JP); Yuki MASUDA, Kariya-shi (JP); Takeshi KONDO, Kariya-shi (JP); Tomokuni ABE, Kariya-shi (JP)

(21) Appl. No.: 18/822,470

(22) Filed: Sep. 3, 2024

(30) Foreign Application Priority Data
Sep. 19, 2023 (JP) 2023-151593

(51) Int. Cl. H01M 4/04; H01M 4/36

(52) U.S. Cl. CPC H01M 4/043; H01M 4/0471; H01M 4/366

(57) ABSTRACT

An electrode production method that can suppress the thickness nonuniformity in an electrode is provided. The electrode production method includes: forming a first active material layer on a first face of a current collector; pressing the first active material layer for the first time; and pressing the first active material layer for the second time after said first pressing, wherein the proportion of a pressing linear pressure P2 in said second pressing to a pressing linear pressure P1 in said first pressing is 100% to 200%.

### FIELD

The present application relates to a method of producing an electrode, and a method of producing a secondary battery.

### BACKGROUND

An electrode as secondary battery equipment is produced by forming an active material layer on a current collector, and thereafter, in order to adjust density, pressing the resultant at a predetermined pressure. For example, patent literature 1 discloses a bipolar electrode production method comprising: forming an anode active material layer on a first face of a first metal foil; pressing the anode active material layer in the state where a first face of a second metal foil faces a second face of the first metal foil; forming a cathode active material layer on a second face of the second metal foil; and pressing the cathode active material layer.

### CITATION LIST

### Patent Literature

Patent Literature 1: JP 2021-82504 A

### SUMMARY

### Technical Problem

As described above, the active material layer is pressed in order to adjust the density thereof. However, after the pressing, the residual stress at the time of the pressing may be released over time to increase the thickness of the active material layer. That is, springback may be made on the active material layer. This leads to thickness nonuniformity in the active material layer. Therefore, the density of the active material layer changes, and the quality of the electrode becomes unstable, which is problematic.

The inventors of the present disclosure have acquired the knowledge that the foregoing problem cannot be settled enough even by the electrode production method disclosed in patent literature 1, which comprises: pressing an anode active material layer twice. This unsettlement is considered to be because the pressing linear pressure for the second time is set lower than that for the first time in patent literature 1. Generally, the conveying direction component is smaller in the second pressing because the direction where the surface pressure is applied is closer to the vertical direction. Then, in the second pressing, the active material layer is short of the plastic deformation irreversible deformation, and therefore, the springback thereof becomes large. Accordingly, the inventors of the present disclosure have acquired the knowledge that the electrode production method disclosed in patent literature 1 cannot fully suppress the thickness nonuniformity in an active material layer.

With the foregoing actual circumstances in view, a main object of the present disclosure is to provide an electrode production method that can suppress the thickness nonuniformity in an electrode.

### Solution to Problem

The present disclosure provides at least the following aspects.

The first aspect is a method of producing an electrode, the method comprising: forming a first active material layer on a first face of a current collector; pressing the first active material layer for a first time; and pressing the first active material layer for a second time after said first pressing, wherein a proportion of a pressing linear pressure P2 in said second pressing to a pressing linear pressure P1 in said first pressing is 100% to 200%.

The second aspect is the method according to the first aspect, wherein the proportion is 100% to 125%.

The third aspect is the method according to the first or second aspect, further comprising: heating the first active material layer between said first pressing and said second pressing.

The fourth aspect is the method according to any one of the first to third aspects, further comprising: forming a second active material layer on a second face of the current collector between said first pressing and said second pressing.

The fifth aspect is a method of producing a secondary battery, the method comprising: preparing an electrode by the electrode production method according to any one of the first to fourth aspects; and preparing a secondary battery by use of the electrode.

### Advantageous Effects

The electrode production method according to the present disclosure can suppress the thickness nonuniformity in the electrode. The secondary battery production method according to the present disclosure can improve the quality of the battery.

### BRIEF DESCRIPTION OF DRAWINGS

FIG. 1 is a flowchart of the first embodiment;

FIG. 2 is a schematic view illustrating the first pressing step S12;

FIG. 3 is a flowchart of the second embodiment; and

FIG. 4 is a schematic view illustrating the second pressing step S25.

### DESCRIPTION OF EMBODIMENTS

### [Electrode Production Method]

An electrode production method according to the present disclosure will be described in detail by using the first and second embodiments.

### First Embodiment

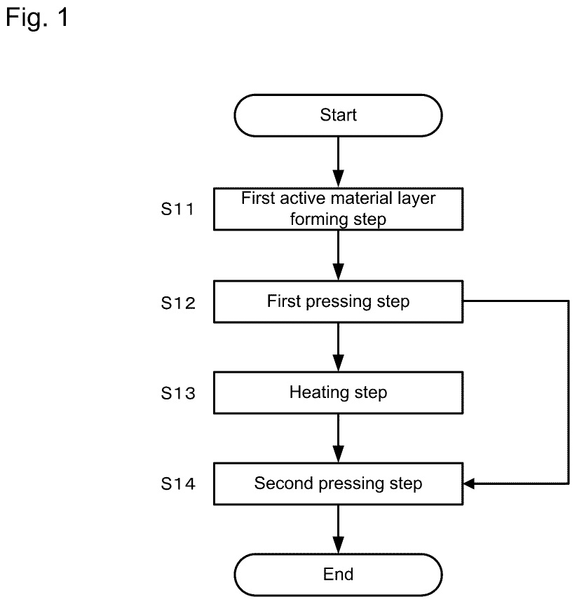

FIG. 1 shows a flowchart of the first embodiment. As shown in FIG. 1, the first embodiment comprises a first active material layer forming step S11, a first pressing step S12, a heating step S13, and a second pressing step S14. Hereinafter each of the steps will be described.

### (First Active Material Layer Forming Step S11)

The first active material layer forming step S11 is the step of forming a first active material layer 20 on a first face 11 of a current collector 10.

The current collector 10 is a sheet-like electroconductive member that is rectangular in a plan view. The current collector 10 has the first face 11, and a second face 12 sitting on the opposite side of the first face 11. The current collector 10 is formed of, for example, a metal foil or an alloy foil. Examples of a metal foil as used herein include a copper foil, an aluminum foil, a titanium foil, and a nickel foil. Examples of an alloy foil as used herein include a stainless steel foil, a plated steel plate, and a plated stainless steel plate. This alloy foil may be an alloy foil of any metals shown as examples of the material of the abovementioned metal foil. The current collector 10 may be formed by uniting, into one body, or laminating a plurality of sheets of a metal foil, and may be formed by plating another metal on the surface of a metal foil.

The first active material layer 20 is a sheet-like active material layer, and contains a cathode or anode active material.

Examples of a cathode active material as used herein include: complex oxides, metallic lithium, and sulfur. For example, the composition of a complex oxide as used herein includes lithium, and at least one of iron, manganese, titanium, nickel, cobalt, and aluminum. Examples of a complex oxide as used herein include olivinic lithium iron phosphate (LiFePO₄), LiCoO₂, and LiNiMnCoO₂.

Examples of an anode active material as used herein include carbon such as graphite, artificial graphite, highly oriented graphite, mesocarbon microbeads, hard carbon, and soft carbon; metallic compounds; any element that can form an alloy with lithium, and compounds thereof; and boron-doped carbon. Examples of an element that can form an alloy with lithium as used herein include silicon and tin.

The first active material layer 20 may optionally contain a conductive additive. Examples of a conductive additive as used herein include acetylene black, carbon black, and graphite.

The first active material layer 20 may optionally contain a binder. Examples of a binder as used herein include fluorine-containing resins such as polyvinylidene fluoride, polytetrafluoroethylene, and fluorocarbon rubber; thermoplastic resins such as polypropylene and polyethylene; imide resins such as polyimide and polyamideimide; alkoxysilyl group-containing resins; acrylic resins having a monomer unit such as acrylic acid and methacrylic acid; styrene-butadiene rubber (SBR); carboxymethyl cellulose; alginates such as sodium alginate, and ammonium alginate; water-soluble cellulose ester crosslinked products; and starch-acrylic acid graft polymers.

The first active material layer 20 may optionally contain a solid electrolyte. Examples of a solid electrolyte as used herein include oxide solid electrolytes, sulfide solid electrolytes, and nitride solid electrolytes.

When containing a cathode active material, the first active material layer 20 is a cathode active material layer. When containing an anode active material, the first active material layer 20 is an anode active material layer. Accordingly, the first active material layer 20 may be a cathode active material layer, and may be an anode active material layer. In view of further checking an increase in electrode thickness caused by springback, the first active material layer 20 may be an anode active material layer because, typically, a higher density of an anode active material layer than a cathode active material layer is desired.

The method of forming the first active material layer 20 on the first face 11 of the current collector 10 is not particularly limited, but any known method may be appropriately employed. Examples of this method include roll coating, die coating, dip coating, doctor blade, spray coating, and curtain coating. Specifically, the first active material layer can be formed by mixing, with a solvent, the electrode material to constitute the first active material layer to obtain a slurry, and thereafter applying and drying the slurry onto the first face 11 of the current collector 10. Examples of a solvent as used herein include N-methyl-2-pyrrolidone, methanol, methyl isobutyl ketone, and water.

### (First Pressing Step S12)

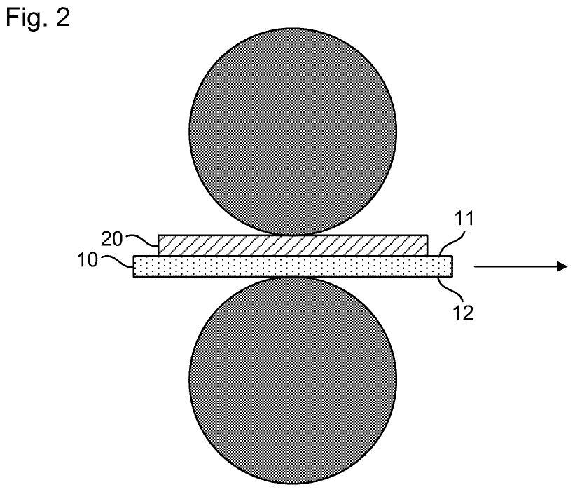

The first pressing step S12 is the step of pressing the first active material layer 20 which is performed after the first active material layer forming step S11. Roll pressing may be employed for the method of performing the pressing. FIG. 2 is a schematic view illustrating the first pressing step S12.

The pressing linear pressure P1 in the first pressing step S12 is not particularly limited, but may be, for example, 3 kN/cm to 5 kN/cm. The pressing linear pressure P1 in the first pressing step S12 shall be equal to or lower than the pressing linear pressure P2 in the second pressing step S14. More details thereon will be described later.

### (Heating Step S13)

The heating step S13 is the step of heating the first active material layer 20 which is performed between the first pressing step S12 and the second pressing step S14. Carrying out the heating step S13 releases residual stress in the first active material layer 20. Therefore, carrying out the heating step S13 can further suppress the thickness nonuniformity in the electrode. The heating step S13 is an optional step, and is not necessarily performed.

The heating step S13 may be carried out in an air atmosphere, and may be carried out in an inert gas atmosphere. The heating temperature is not particularly limited, but is, for example, 120° C. to 150° C. When the heating temperature is lower than 120° C., the residual stress in the first active material layer 20 cannot be released enough. When the heating temperature exceeds 150° C., the first active material layer 20 may deteriorate. The heating time is not particularly limited, but is, for example, 1 minute to 5 minutes. When the heating time is shorter than 1 minute, the residual stress in the first active material layer 20 cannot be released enough. When the heating time is 5 minutes or longer, the first active material layer 20 may deteriorate.

### (Second Pressing Step S14)

The second pressing step S14 is the step of pressing the first active material layer 20 which is performed after the heating step S13. When the heating step S13 is not carried out, the second pressing step S14 is carried out after the first pressing step S12.

Roll pressing may be employed for the method of performing the pressing (see FIG. 2). The pressing linear pressure P2 in the second pressing step S14 is not particularly limited, but may be, for example, 4 kN/cm to 6 kN/cm.

Here, the feature of the first embodiment is that the proportion of the pressing linear pressure P2 in the second pressing step S14 to the pressing linear pressure P1 in the first pressing step S11 (P2/P1) is 100% to 200%.

Typically, the first active material layer 20 is pressed in order to adjust the density thereof. However, the residual stress at the time of the pressing is released over time to increase the thickness of the first active material layer 20. That is, springback is made on the first active material layer 20, which leads to thickness nonuniformity in the first active material layer 20. Therefore, the density of the first active material layer 20 changes, and the quality of the electrode becomes unstable, which is problematic. For this, in the first embodiment, the first active material layer 20 is pressed at least twice. In addition, the feature of the first embodiment is that the proportion of the pressing linear pressure P2 in the second pressing step S14 to the pressing linear pressure P1 in the first pressing step S11 (P2/P1) is 100% to 200%. These can improve the fluidity of particles forming the first active material layer 20, disperse the residual stress, and make the plastic deformation irreversible deformation (conveying direction component of the pressing surface pressure) larger. Thus, an increase in thickness of the first active material layer caused by springback can be checked. Accordingly, the first embodiment can suppress the thickness nonuniformity in the electrode.

When the proportion (P2/P1) is lower than 100%, the plastic deformation irreversible deformation of the first active material layer 20 is smaller, and an increase in the thickness of the first active material layer caused by springback cannot be checked enough. When the proportion (P2/P1) exceeds 200%, the vertical direction component of the pressing surface pressure is larger, and the springback caused by the elastic deformation of the active material layer increases. Thus, an increase in thickness of the first active material layer cannot be checked enough. In view of further heightening the effect, the proportion (P2/P1) may be 100% to 125%, and may be higher than 100% and at most 125%.

### Second Embodiment

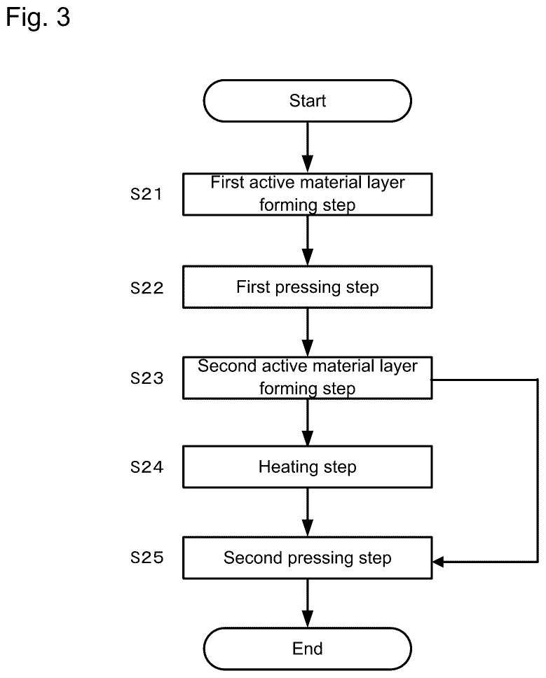

FIG. 3 shows a flowchart of the second embodiment. As shown in FIG. 3, the second embodiment comprises a first active material layer forming step S21, a first pressing step S22, a second active material layer forming step S23, a heating step S24, and a second pressing step S25. The second embodiment differs from the first embodiment mainly in that the second active material layer forming step S23 is included. Hereinafter each of the steps will be described.

The first active material layer forming step S21 and the first pressing step S22 are the same as the first active material layer forming step S11 and the first pressing step S12 in the first embodiment, and thus, the descriptions thereof are omitted here.

### (Second Active Material Layer Forming Step S23)

The second active material layer forming step S23 is the step of forming a second active material layer 30 on a second face 12 of the current collector 10 which is performed between the first pressing step S22 and the heating step S24.

The second active material layer 30 may be a cathode active material layer, and may be an anode active material layer. The second active material layer 30 may be an active material layer of the same kind as the first active material layer 20, and may be an active material layer of a different kind from the first active material layer 20. Typically, when a monopolar-type secondary battery is aimed, the second active material layer 30 shall be an active material layer of the same kind as the first active material layer. When a bipolar-type secondary battery is aimed, the second active material layer 30 shall be an active material layer a different kind from the first active material layer. Typically, the density of an anode active material layer is set higher than that of a cathode active material layer. In view of this, the first active material layer 20 may be an anode active material layer, and the second active material layer 30 may be a cathode active material layer.

The materials to constitute the second active material layer 30 may be appropriately selected from materials that can constitute the first active material layer 20. The method of forming the second active material layer 30 may be appropriately selected from methods capable of forming the first active material layer 20.

### (Heating Step S24)

The heating step S24 is the step of heating the first active material layer 20 and the second active material layer 30 which is performed between the second active material layer forming step S23 and the second pressing step S25. The heating step S24 is different from the heating step S13 of the first embodiment in that, in addition to the first active material layer 20, the second active material layer 30 is heated. However, the heating method is the same as in the heating step S13. Therefore, a detailed description thereof is omitted. The heating step S24 is an optional step, and is not necessarily performed.

### (Second Pressing Step S25)

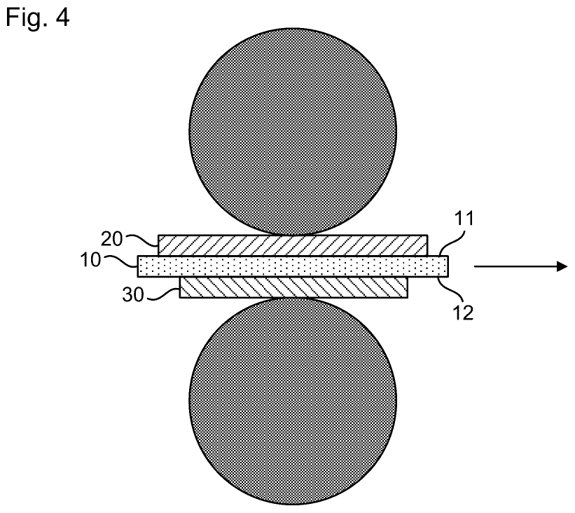

The second pressing step S25 is the step of pressing the first active material layer 20 and the second active material layer 30 which is performed after the heating step S24. When the heating step S24 is not carried out, the second pressing step S25 is carried out after the first pressing step S22. The second pressing step S25 differs from the second pressing step S14 of the first embodiment in that, in addition to the first active material layer 20, the second active material layer 30 is pressed. The pressing method is the same as in the second pressing step S14. FIG. 4 shows a schematic view illustrating the second pressing step S25.

Here, as well as the first embodiment, the feature of the second embodiment is that the proportion of the pressing linear pressure P2 in the second pressing step S25 to the pressing linear pressure P1 in the first pressing step S21 (P2/P1) is 100% to 200%. In view of further heightening the effect, the proportion (P2/P1) may be 100% to 125%, and may be higher than 100% and at most 125%.

The second embodiment has the foregoing feature, and thereby, as well as the first embodiment, can check an increase in thickness of the first active material layer caused by springback. Accordingly, the second embodiment can suppress the thickness nonuniformity in the electrode.

The electrode production method according to the present disclosure has been described above using the first and second embodiments. In the electrode production method according to the present disclosure, an increase in thickness of the electrode caused by springback is checked. Accordingly, the electrode production method according to the present disclosure can suppress the thickness nonuniformity in the electrode.

### [Secondary Battery Production Method]

A secondary battery production method according to the present disclosure will be described using one embodiment. The one embodiment comprises the steps of: preparing an electrode by the aforementioned electrode production method; and preparing a secondary battery by the use of the electrode. The electrode preparing step has been described above, and thus, the description thereof is omitted here.

### <Secondary Battery Preparing Step>

The secondary battery preparing step is the step of preparing a secondary battery by the use of the electrode obtained in the electrode preparing step. Such a secondary battery preparing step is known. Hereinafter the secondary battery preparing step will be described using a typical example, but is not limited to this embodiment.

When the electrode obtained in the electrode preparing step is a cathode, the secondary battery is prepared by using an anode and an electrolyte layer which are separately prepared. When the electrode obtained in the electrode preparing step is an anode, the secondary battery is prepared by using a cathode and an electrolyte layer which are separately prepared. For example, the secondary battery (monopolar-type secondary battery) can be obtained by disposing an electrolyte layer between a cathode and an anode.

When the electrode obtained in the electrode preparing step is a bipolar electrode, a secondary battery is prepared by using the bipolar electrode and an electrolyte layer. For example, the secondary battery (bipolar-type secondary battery) can be obtained by disposing an electrolyte layer between the bipolar electrodes.

When being a liquid electrolyte layer, an electrolyte layer as used herein is obtained by disposing a separator between the electrodes, and then supplying an electrolytic solution to the separator. A separator as used herein is a porous sheet mainly formed from a polyolefin. An electrolytic solution as used herein is such that a supporting salt dissolves in a nonaqueous solvent. Examples of a nonaqueous solvent as used herein include carbonates, ethers, and esters. Examples of a supporting salt as used herein include LiPF₆, LiBF₄, lithium bis(fluorosulfonyl)imide (LiFSI), and lithium bis(trifluoromethane) sulfonimide (LiTFSI).

When an electrolyte layer as used herein is a solid electrolyte layer, the battery can be produced by disposing the solid electrolyte layer between the electrodes. The solid electrolyte layer contains a solid electrolyte. The solid electrolyte layer may contain a binder. A solid electrolyte and a binder as used herein may be appropriately selected from the aforementioned solid electrolytes and binders.

The secondary battery production method according to the present disclosure has been described above using the one embodiment. In the secondary battery production method according to the present disclosure, the electrode is prepared based on the aforementioned electrode production method. Thus, the thickness nonuniformity in the electrode is suppressed. Accordingly, the secondary battery production method according to the present disclosure can improve the quality of the battery.

### EXAMPLES

The present disclosure will be further described using examples. Each electrode was pressed based on table 1. Hereinafter each of examples and comparative examples will be described.

### Comparative Example 1

A metal foil was coated with a slurry of 36 mg/cm² in coating weight which contained an anode material. The coating slurry was dried at 100° C. for 10 minutes to form an anode active material layer. Subsequently, the anode active material layer was roll-pressed, and the resultant anode electrode of comparative example 1 was obtained.

Here, a laminated foil of aluminum and copper was used as the metal foil. Graphite was used as the anode material. A conductive material, a binder, etc. were contained in the anode material. An ion-exchanged water was used as a solvent used for the slurry.

### <Comparative Example 2 and Examples 1 to 3>

An anode active material layer was formed on a metal foil in the same manner as in comparative example 1. Subsequently, the anode active material layer was roll-pressed twice, and the resultant anode electrode of each of comparative example 2 and examples 1 to 3 was obtained.

### Example 4

An anode active material layer was formed on a metal foil in the same manner as in comparative example 1. Subsequently, the anode active material layer was roll-pressed for the first time, and thereafter heated. The heating conditions were: 120° C. in temperature; and 1 minute in time. Thereafter, the anode active material layer was roll-pressed for the second time, and the resultant anode electrode of example 4 was obtained.

### Comparative Example 3

A first face of a metal foil was coated with a slurry of 36 mg/cm² in coating weight which contained an anode material, and a second face of the metal foil was coated with a slurry of 72 mg/cm² in coating weight which contained a cathode material. The coating slurry was dried at 100° C. for 10 minutes to form an anode active material layer and a cathode active material layer. Subsequently, the anode active material layer and the cathode active material layer were roll-pressed, and the resultant bipolar electrode of comparative example 3 was obtained.

The same anode material as in comparative example 1 was used. As the cathode material, lithium iron phosphate was used. A conductive material, a binder, etc. were contained in the cathode material. The same solvent as in comparative example 1 was used as the solvent used for the slurry.

### <Comparative Example 4 and Example 5>

A first face of a metal foil was coated with a slurry of 36 mg/cm² in coating weight which contained an anode material, and dried at 100° C. for 10 minutes to form an anode active material layer. Subsequently, the anode active material layer was roll-pressed (for the first time). Subsequently, a second face of the metal foil was coated with a slurry of 72 mg/cm² in coating weight which contained a cathode material, and dried at 100° C. for 10 minutes to form a cathode active material layer. Next, the anode active material layer and the cathode active material layer were roll-pressed (for the second time), and the resultant bipolar electrode of each of comparative example 4 and example 5 was obtained. The same anode material, cathode material, and solvent as in comparative example 3 were used.

### Example 6

A first face of a metal foil was coated with a slurry of 36 mg/cm² in coating weight which contained an anode material, and dried at 100° C. for 10 minutes to form an anode active material layer. Next, the anode active material layer was roll-pressed (for the first time). Subsequently, a second face of the metal foil was coated with a slurry of 72 mg/cm² in coating weight which contained a cathode material, and dried at 100° C. for 10 minutes to form a cathode active material layer. Next, the anode active material layer and the cathode active material layer were heated. The heating conditions were: 120° C. in temperature; and 1 minute in time. Then, the anode active material layer and the cathode active material layer were roll-pressed (for the second time), and the resultant bipolar electrode of example 6 was obtained. The same anode material, cathode material, and solvent as in comparative example 3 were used.

[Table 1]

TABLE 1

| | | | | Proportion of pressing | | Density of anode active material layer | | |
|---|---|---|---|---|---|---|---|---|
| | | Pressing linear pressure (kN/cm) | | linear pressure | | after pressing (g/cm³) | | Springback |
| | Electrode | First time (P1) | Second time (P2) | (P2/P1 (%)) | Heating | First time | Second time | (μm) |
| Comparative | anode | 6 | — | — | — | 1.25 | — | 46 |
| example 1 | | | | | | | | |
| Comparative | anode | 6 | 5 | 83 | — | 1.26 | 1.26 | 44 |
| example 2 | | | | | | | | |
| Comparative | bipolar | 6 | — | — | — | 1.24 | — | 45 |
| example 3 | | | | | | | | |
| Comparative | bipolar | 6 | 5 | 83 | — | 1.26 | 1.26 | 45 |
| example 4 | | | | | | | | |
| Example 1 | anode | 4.5 | 4.5 | 100 | — | 1.22 | 1.26 | 19 |
| Example 2 | anode | 4 | 5 | 125 | — | 1.2 | 1.26 | 23 |
| Example 3 | anode | 3 | 5.5 | 183 | — | 1.15 | 1.26 | 30 |
| Example 4 | anode | 4 | 5 | 125 | heated | 1.2 | 1.25 | 19 |
| Example 5 | bipolar | 4 | 5 | 125 | — | 1.19 | 1.25 | 24 |
| Example 6 | bipolar | 4 | 5 | 125 | heated | 1.2 | 1.25 | 17 |

Here, “Springback” shown in table 1 was obtained by the following method. First, each of the electrodes was heated under the conditions of 120° C. in temperature, and 1 minute in time, so that the anode active material layer sprang back. Then, the springback was calculated from the difference between the thickness of the anode active material layer before the heating, and that after the heating. Further, the density of the anode active material layer after the springback was measured. The obtained density was shown in the column starting from Second time of “Density of anode active material layer after pressing (g/cm³)” in table 1.

### <Results>

The springback in each of examples 1 to 6 was less than that in each of comparative examples 1 to 4. The similar results were obtained irrespective of whether the electrode was the anode or the bipolar electrode. From this, it can be understood that for reducing the springback, it is essential that the proportion of the pressing linear pressure (P2/P1) be at least 100%. Specifically, when the proportion of the pressing linear pressure (P2/P1) was 100% to 125%, the result such that the springback was further less was obtained.

### REFERENCE SIGNS LIST

10 current collector
11 first face
12 second face
20 first active material layer
30 second active material layer

What is claimed is:

1. A method of producing an electrode, the method comprising:
forming a first active material layer on a first face of a current collector;
pressing the first active material layer for a first time; and
pressing the first active material layer for a second time after said first pressing, wherein
a proportion of a pressing linear pressure P2 in said second pressing to a pressing linear pressure P1 in said first pressing is 100% to 200%.

2. The method according to claim 1, wherein the proportion is 100% to 125%.

3. The method according to claim 1, further comprising:
heating the first active material layer between said first pressing and said second pressing.

4. The method according to claim 1, further comprising:
forming a second active material layer on a second face of the current collector between said first pressing and said second pressing.

5. A method of producing a secondary battery, the method comprising:
preparing an electrode by the electrode production method according to claim 1; and
preparing a secondary battery by use of the electrode.
